(19) United States
(12) Patent Application Publication
(10) Pub. No.: US 2017/0277454 A1
(43) Pub. Date: Sep. 28, 2017

(54) MEMORY DEVICE AND OPERATING METHOD THEREOF

(71) Applicant: SK hynix Inc., Gyeonggi-do (KR)

(72) Inventor: Beom Ju SHIN, Gyeonggi-do (KR)

(21) Appl. No.: 15/244,641

(22) Filed: Aug. 23, 2016

(30) Foreign Application Priority Data
Mar. 23, 2016 (KR) 10-2016-0034761

(51) Int. Cl. G06F 3/06

(52) U.S. Cl. CPC G06F 3/0619; G06F 3/0604; G06F 3/0653; G06F 3/068

(57) ABSTRACT

Provided herein are a memory device and an operating method thereof. The memory device includes: a memory device comprising: a memory cell array including a plurality of pages; a peripheral circuit suitable for successively receiving a plurality of logical page data, and performing a program operation with the received logical page data to a selected page; and a control logic suitable for controlling the peripheral circuit to perform, in parallel, the program operation to the selected page with reception-completed logical page data among the plurality of logical page data while receiving other logical page data.

### CROSS-REFERENCE TO RELATED APPLICATION

The present application claims priority under 35 U.S.C. §119(a) to Korean patent application number 10-2016-0034761 filed on Mar. 23, 2016, which is incorporated herein in its entirety by reference.

### BACKGROUND

Field of Invention

Various embodiments of the present disclosure relate generally to a memory device and an operating method thereof and, more particularly, to an improved program operation of the memory device.

Description of Related Art

A memory device performs a program operation for storing data according to a command and an address which are received from a memory controller. For this, the memory device may include a memory cell array which stores data, a peripheral circuit which performs a program operation, and a control logic which controls the peripheral circuit.

The memory cell array may include a plurality of planes, each plane including a plurality of memory blocks. Each memory block may include a plurality of strings, each string including a plurality of memory cells.

The strings may be embodied in a two or three dimensional structure. A memory device including strings forming a two-dimensional structure is referred to as a two-dimensional memory device. A memory device including strings forming a three-dimensional structure is referred to as a three-dimensional memory device.

Strings of the two-dimensional memory device may include memory cells which are arranged parallel with a substrate. Strings of the three-dimensional memory device may include memory cells which are arranged perpendicular to a substrate.

Recently, research on three-dimensional memory devices which have a reduced area and an increased degree of integration compared to two-dimensional memory devices has become appreciably more active.

### SUMMARY

Various embodiments of the present disclosure are directed to a three-dimensional memory device capable of performing an improved program operating method, and the program operating method itself. The present invention offers improved data reliability.

One embodiment of the present disclosure provides a memory device comprising: a memory cell array including a plurality of pages; a peripheral circuit suitable for successively receiving a plurality of logical page data, and performing a program operation with the received logical page data to a selected page; and a control logic suitable for controlling the peripheral circuit to perform, in parallel, the program operation to the selected page with reception-completed logical page data among the plurality of logical page data while receiving other logical page data.

Another embodiment of the present disclosure provides an operating method of a memory device comprising: receiving first to Nth logical page data; performing a program operation to a selected page with reception-completed one among the first to Nth logical page data; and receiving the other logical page data during the performing of the program operation with the reception-completed logical page data.

Another embodiment of the present disclosure provides an operating method of a memory device comprising: receiving least significant bit (LSB) data, central significant bit (CSB) data and most significant bit (MSB) data performing a program operation to a selected page with the LSB data, which is reception-completed; receiving the CSB data and the MSB data during the performing of the program operation with the reception-completed LSB data; and performing the program operation to the selected page with the CSB and MSB data after the performing of the program operation with the reception-completed LSB data and the receiving of the CSB and MSB data.

### BRIEF DESCRIPTION OF THE DRAWINGS

Example embodiments will now be described more fully hereinafter with reference to the accompanying drawings however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a diagram illustrating a memory system, according to an embodiment of the present disclosure;

FIG. 2 is a diagram illustrating in detail an example configuration of the memory device of FIG. 1;

FIG. 3 is a flowchart illustrating a program operation of the memory system of FIG. 1, according to a first embodiment of the present disclosure;

FIG. 4 is a flowchart illustrating a program operation of the memory system of FIG. 1, according to a second embodiment of the present disclosure;

FIG. 5 is a flowchart illustrating a program operation of the memory system of FIG. 1, according to a third embodiment of the present disclosure;

FIG. 6 is a diagram illustrating an example configuration of the control logic of FIG. 2;

FIG. 7 is a diagram illustrating an operating method of the control logic of FIG. 2;

FIG. 8 is a diagram illustrating a memory device including a plurality of planes, according to an embodiment of the present disclosure;

FIG. 9 is a diagram illustrating a program operation according to a fourth embodiment of the present disclosure;

FIG. 10 is a diagram illustrating a memory system, according to another embodiment of the present disclosure; and

FIG. 11 is a diagram illustrating a memory system according to yet another embodiment of the present disclosure.

### DETAILED DESCRIPTION

Hereinafter, various embodiments of the present disclosure will be described in reference to the drawings. In the following description, only parts required for understanding of operations in accordance with the present disclosure will be described, and explanation of the other parts will be omitted to avoid obscuring the disclosure with well-known material that is not needed for understanding the present invention. Accordingly, the present invention is not limited to the following described embodiments but may also be embodied in other forms. Rather, these embodiments are provided so that the present disclosure will be thorough, and complete, and will fully convey the present invention to those skilled in the art.

It will be understood that when an element is referred to as being “coupled” or “connected” to another element, it can be directly coupled or connected to the other element or intervening elements may be present therebetween.

It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the present invention.

The drawings are not necessarily to scale and, in some instances, proportions may have been exaggerated in order to more clearly illustrate the various elements of the embodiments. For example, in the drawings the size of elements and the intervals between elements may be exaggerated compared to actual sizes and intervals for convenience of illustration.

The terminology used herein is for the purpose of describing particular embodiments only and is not intended to be limiting of the present invention. As used herein, singular forms are intended to include the plural forms as well, unless the context clearly indicates otherwise. It will be further understood that the terms “comprises”, “comprising”, “includes”, and “including” when used in this specification, specify the presence of the stated elements and do not preclude the presence or addition of one or more other elements.

As used herein, the term “and/or” includes any and all combinations of one or more of the associated listed items.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, a feature or element described in connection with one embodiment may be used singly or in combination with other features or elements of another embodiment, unless otherwise specifically indicated.

Hereinafter, the various embodiments of the present invention will be described in detail with reference to the attached drawings.

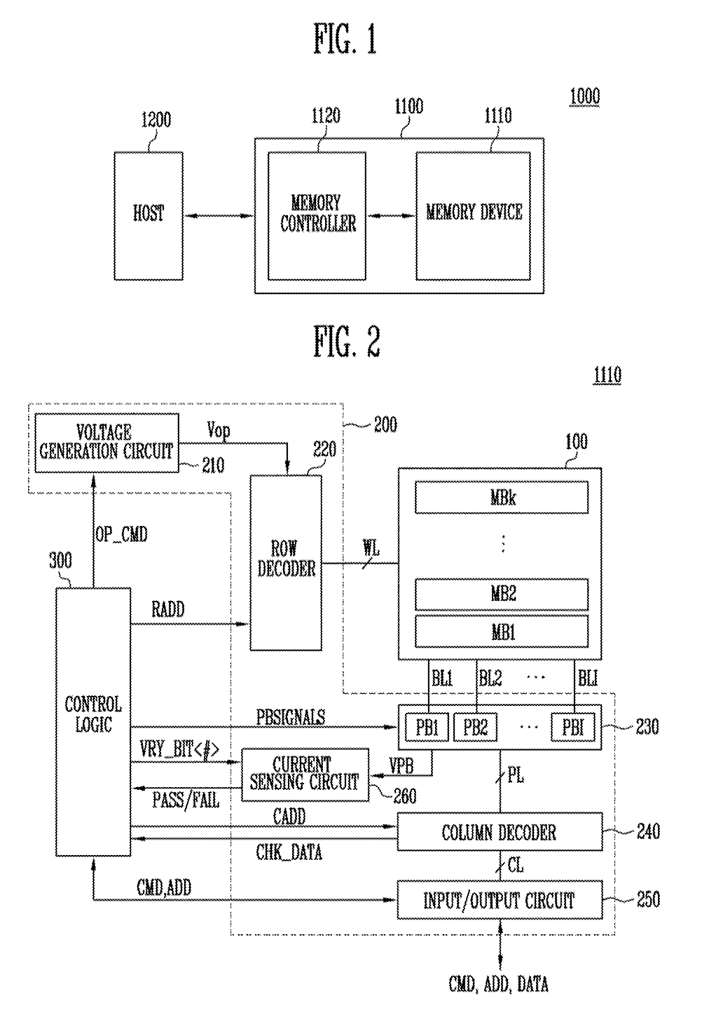

FIG. 1 is a diagram illustrating a memory system 100, according to an embodiment: of the present disclosure

Referring to FIG. 1, the memory system 1000 may include a storage device 1100 and a host 1200 operatively coupled to the storage device 1100. The storage device 1100 may include a memory device 1110 configured to store data, and a memory controller 1120 for controlling the memory device 1110.

The host 1200 may communicate with the storage device 1100 through any suitable interface protocol, such as a Peripheral Component Interconnect-Express (PCI-E), an Advanced Technology Attachment (ATA), a Serial ATA (SATA), a Parallel ATA (PATA), or a Serial Attached SCSI (SAS), a Universal Serial Bus (USB), a Multi-Media Card (MMC), an Enhanced Small Disk Interface (ESDI), an Integrated Drive Electronics (IDE) and the like,

The memory controller 1120 controls the operation of the storage device 1100 and controls data exchange between the host 1200 and the memory device 1110. For example, the memory controller 1120 may control the memory device 1110 so that a program, read, or erase operation is performed according to a request from the host 1200. As an example, for a program operation, the memory controller 1120 may transmit a command, an address and data to the memory device 1110, and the memory device 1110 may perform a program operation in accordance with the received command, address and data.

The memory device 1110 may be or include a Double Data Rate Synchronous Dynamic Random Access Memory (DDR SDRAM), a Low Power Double Data Rate4 (LPDDR4) SDRAM, a Graphics Double Data Rate (GDDR) SDRAM, Low Power DDR (LPDDR), a Rambus Dynamic Random Access Memory (RDRAM), or a FLASH Memory. An embodiment wherein the memory device 1110 is configured with a plurality of flash memories will be exemplarily explained.

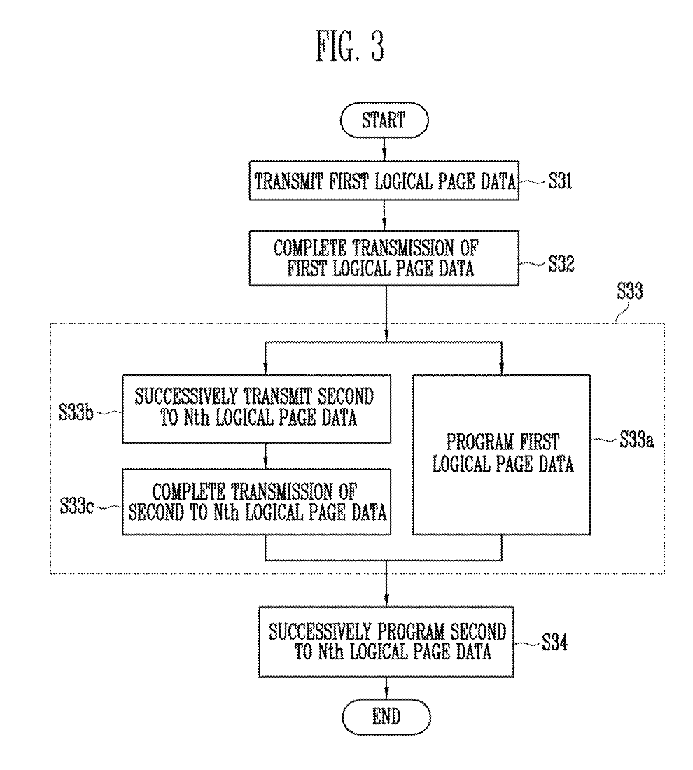

FIG. 2 is a diagram illustrating in detail an example configuration of the memory device 1110 of FIG. 1.

Referring to FIG. 2, the memory device 1110 may include a memory cell array 100 in which data is stored, a peripheral circuit 200 configured to perform a program operation for storing data in the memory cell array 100, a read operation for outputting the stored data, and an erase operation for erasing the stored data, and a control logic 300 for controlling the peripheral circuit 200.

The memory cell array 100 may include a plurality of memory blocks MB1 to MBk (k is a positive integer). Word lines WL and bit lines BL1 to BLI (I is a positive integer) may be coupled to each of the memory blocks MB1 to MBk. The word lines WL may be respectively coupled to the memory blocks, and the bit lines BL1 to BLI may be coupled in common to the memory blocks. Although not illustrated in FIG. 2, besides the word lines WL, source select lines, drain select lines, or pipe lines may be coupled to each of the memory blocks MB1 to MBk. A group of memory cells coupled to a single word line refers to a physical page. In a multi-level cell type program operation, a plurality of logical page data may be stored in a single physical page.

The peripheral circuit 200 may include a voltage generating circuit 210, a row decoder 220, a page buffer unit 230, a column decoder 240, an input/output circuit 250, and a current sensing circuit 260.

The voltage generating circuit 210 may generate various operating voltages Vop used for a program, read, or erase operation in response to an operation signal OP_CMD. For example, the voltage generating circuit 210 may generate operating voltages Vop such as a program voltage, a read voltage, an erase voltage a pass voltage and a turn-on voltage. Any suitable voltage generating circuit may be employed.

The row decoder 220 may deliver the operating voltages Vop received from the voltage generating circuit 210 to one or more word lines WL coupled to memory blocks selected in response to a row address RADD.

The page buffer unit 230 may include a plurality of page buffers PB1 to PBI coupled to the bit lines BL1 to BLI. The page buffers PB1 to PBI may operate in response to page buffer control signals PBSIGNALS received from the control logic. The page buffers PB1 to PBI may temporarily store data received through the bit lines BL1 to BLI. The page buffers PB1 to PBI may sense voltages or currents of the bit lines BL1 to BLI during a read or verify operation. A verify operation may be performed during a program operation. A verify operation may be performed during an erase operation.

To perform a multi-level cell program operation, the page buffers PB1 to PBI may temporarily store a plurality of logical page data. For example, the page buffers PB1 to PBI may temporarily store first to Nₜₕ logical page data. The page buffers PB1 to PBI may store least significant bit page data (hereinafter, referred to as LSB data), central significant bit page data (hereinafter, referred to as CSB data), and most significant bit page data (hereinafter, referred to as MSB data). In some cases, the page buffers PB1 to PBI of the memory device 1110 may store more logical page data as well as LSB data, CSB data and MSB data. To store a plurality of logical page data, a plurality of latches may be included in the page buffers PB1 to PBI. Different logical page data may be stored in different latches. For example, the page buffer PB1 may include a plurality of latches. LSB data, CSB data or MSB data may be temporarily stored in each latch.

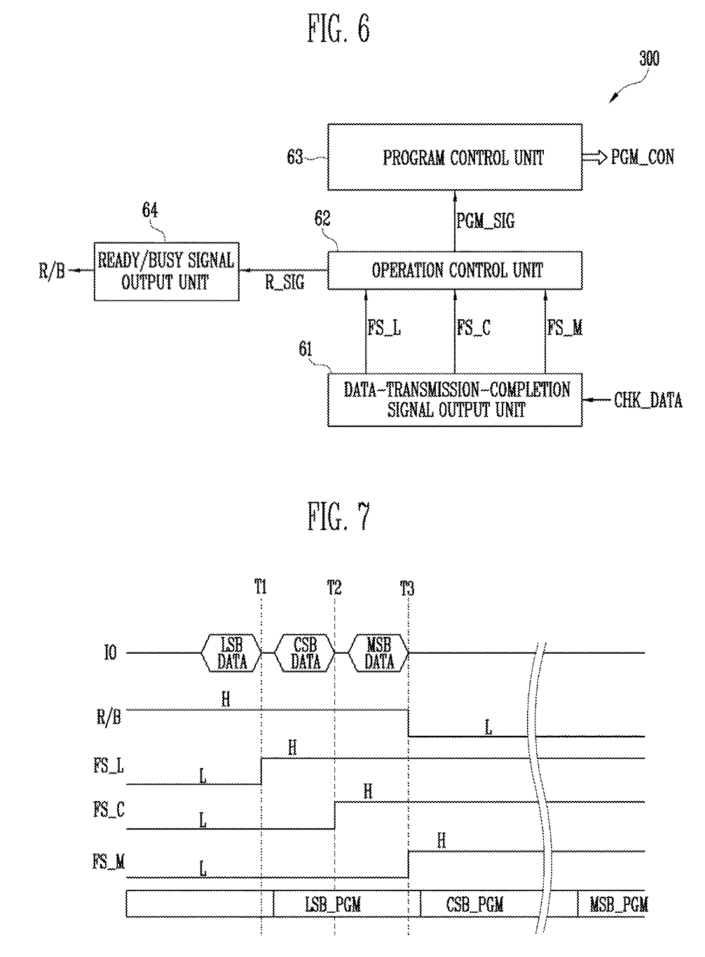

The column decoder 240 may transmit data between the input/output circuit 250 and the page buffer unit 230 in response to a column address CADD. For example, the column decoder 240 may exchange data with the page buffers PB through page lines PL or exchange with the input/output circuit 250 through column lines CL. As will be described with reference to FIG. 6, the column decoder 240 may also provide the same data as provided to the page buffer unit 230.

The input/output circuit 250 may be coupled to the memory controller 1120 through input/output lines and transmit a command CMD or an address ADD received from the memory controller 1120 to the control logic 300 or exchange data DATA with the column decoder 240. Data DATA may include logical page data.

During a read or verify operation, the current sensing circuit 260 may generate a reference current in response to an enable bit VRY_BIT<#>, and may compare a sensing voltage VPB received from the page buffer unit 230 with the reference current to output a pass signal PASS or a fail signal FAIL.

The control logic 300 may output an operation signal OP_CMD, a row address RADD, the page buffer control signals PBSIGNALS, and the enable bit VRY_BIT<#> in response to the command CMD and the address ADD to control the peripheral circuit 200. In addition, the control logic 300 may determine whether the verify operation is passed or fails in response to the pass or fail signal PASS or FAIL. Particularly, the control logic 300 may control the peripheral circuit 200 so that, during a program operation, if reception-completed logical page data is present in logical page data that is received to the memory device 1110, a program operation using the reception-completed logical page data is performed while other logical page data is received. The program operation will be described in detail below.

FIG. 3 is a flowchart illustrating a program operation, according to a first embodiment of the present disclosure.

Referring to FIG. 3, if a program operation has started, the memory controller 1120 may transmit first logical page data to the memory device 1110 at step S31. At step S32, when all of the first logical page data has been transmitted to the memory device 1110, the memory device 1110 performs in parallel a data receiving operation and a program operation at step S33. For example, the memory device 1110 may program reception-completed first logical page data on memory cells included in a page selected according to an address at step S33a. While the memory device 1110 programs the first logical page data on the selected memory cells, the memory controller 1120 may successively transmit the other second to Nₜₕ logical page data to the memory device 1110.

The memory device 1110 may successively receive, while programming the first logical page data on the selected memory cells, the second to Nₜₕ logical page data transmitted from the memory controller 1120 at step S33b. In general since the time it takes to perform the program operation is longer than the time it takes to receive data, all of the second to Nₜₕ logical page data may be transmitted to the memory device 1110 while the first logical page data is programmed on the selected memory cells.

If all of the second to Nₜₕ logical page data have been transmitted to the memory device 1110 at step S33c and the first logical page data has been programmed on the selected memory cells, the memory device 1110 may successively program the received second to Nₜₕ logical page data on memory cells selected according to an address at step S34.

As described above, while reception-completed logical page data is programmed on memory cells, the other logical page data is received on the memory device 1110. Therefore the program operation time may be reduced.

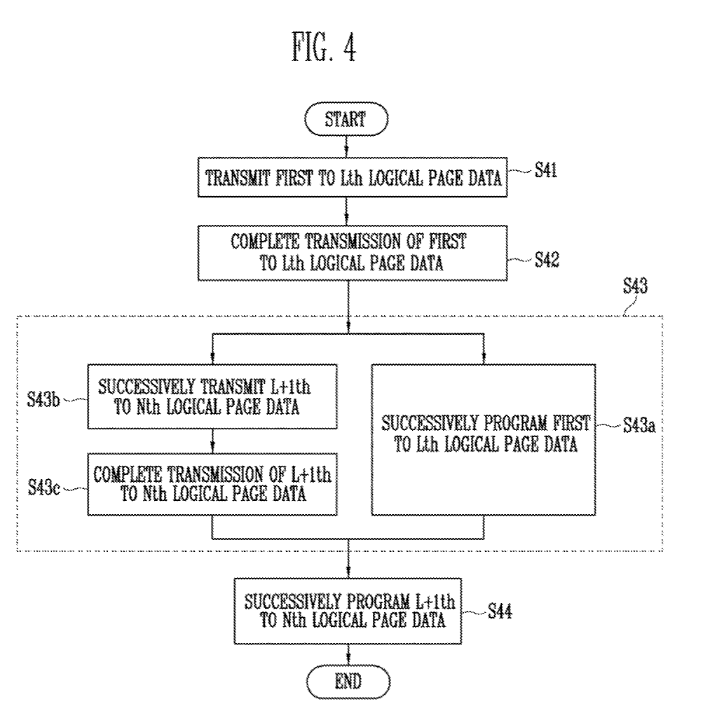

FIG. 4 is a flowchart illustrating a program operation, according to a second embodiment of the present disclosure.

Referring to FIG. 4, if a program operation has started, the memory controller 1120 may transmit first to Lₜₕ logical page data (L is a positive integer) to the memory device 1110 at step S41. If all of the first to Lₜₕ logical page data has been transmitted to the memory device 110 at step S42, the memory device 1110 performs in parallel a data receiving operation and a program operation at step S43. For example, at step S43a, the memory device 1110 may successively program reception-completed first to Lₜₕ logical page data on memory cells included in a page selected according to an address at step S41. While the memory device 1110 programs the first to Lₜₕ logical page data on the selected memory cells, the memory controller 1120 may successively transmit other additional L+1ₜₕ to Nₜₕ logical page data (N is a positive integer, N>L) to the memory device 1110.

The memory device 1110 may successively receive second to Nₜₕ logical page data transmitted from the memory controller 1120 while programming the L+1ₜₕ to Nₜₕ logical page data on selected memory cells at step S43b. In general, because the program operation time is longer than the time it takes to receive data, all of the L+1ₜₕ to Nₜₕ logical page data can be transmitted to the memory device 1110 while the first to Lₜₕ logical page data are programmed on the selected memory cells.

If all of the L+1ₜₕ to Nₜₕ logical page data have been received to the memory device 1110 at step S43c and all of the first to Lₜₕ logical page data have been programmed on the selected memory cells, the memory device 1110 may then, at step S44, successively program the received to Nₜₕ logical page data on memory cells selected according to an address.

As described above, while reception-completed logical page data is programmed on the corresponding memory cells, other logical page data is received to the memory device 1110. Therefore, the program operation time can be reduced.

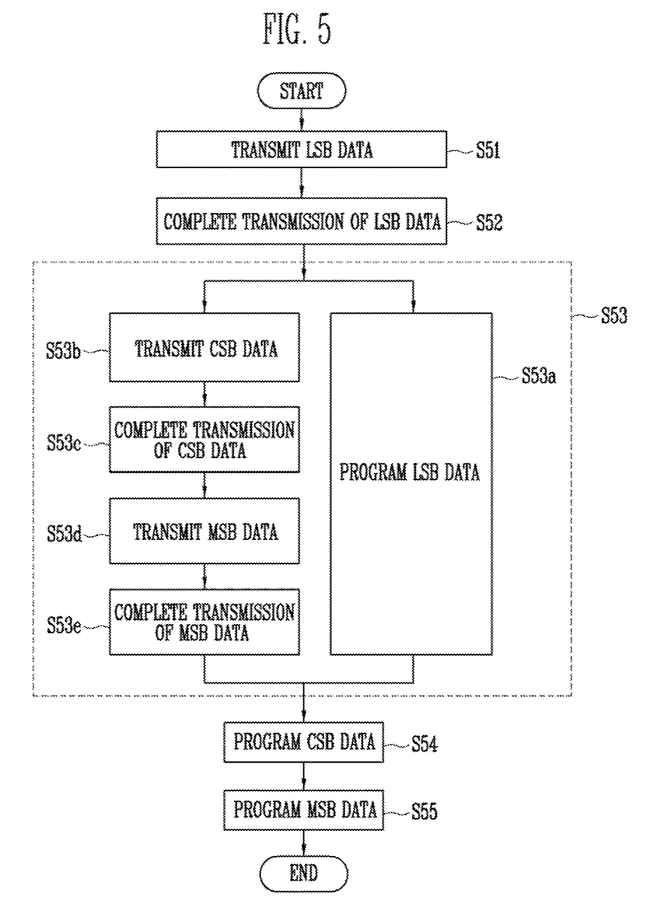

FIG. 5 is a flowchart illustrating a program operation, according to a third embodiment of the present disclosure.

Referring to FIG. 5, there will be described an example of an operation of programming triple level cells (TLCs) in each of which three pieces of logical page data can be stored.

If a program operation has started, the memory controller 1120 may transmit LSB data to the memory device 1110 at step S51. If all of the LSB data have been transmitted to the memory device 1110 and the memory device 1110 has received all of the LSB data at step S52, the memory device 1110 may perform a data receiving operation and a program operation at the same time at step S53.

In detail, if all of the LSB data have been received to the page buffers PB1 to PBI of the memory device 1110, the control logic 300 of the memory device 1110 may control the peripheral circuit 200 so that the received LSB data is programmed on selected memory cells in response to an address at step S53a. While LSB data is programmed, the memory controller 110 may transmit CSB data to the memory device 1110 at step S53b. If all of the CSB data has been transmitted and the memory device 1110 has received all of the CSB data at step S53c, the memory controller 1120 may transmit MSB data to the memory device 1110 at step S53d.

If all of the MSB data have been received to the memory device 1110 at step S53e and all of the LSB data has been programmed on the selected memory cells at step S53a, the memory device 1110 programs the received CSB data on memory cells selected according to an address at step S54. If the operation of programming the CSB data has been completed, the memory device 1110 program the received MSB data on selected memory cells according to an address at step S55.

At the above-mentioned steps, the LSB data, the CSB data and the MSB data may be temporarily stored in the page buffers PB1 to PBI of the memory device 1110. For example, LSB, CSB and MSB data stored in a selected physical page may be respectively stored In first to third latches of the page buffers PB1 to PBI. An operation of programming the LSB data may be performed for memory cells included in the selected physical page after all of the LSB data have been inputted to the first latches of the page buffers PB1 to PBI. While the program operation using the LSB data inputted to the first latches of the page buffers PB1 to PBI is performed, the CSB data may be inputted to the second latches of the page buffers PB1 to PBI. If the input of the CSB data has been completed, the MSB data may be inputted to the third latches.

As described above, while a program operation of programming a plurality of logical page data on a selected page performed, reception-completed logical page data is programmed on selected memory cells and the other logical page data is simultaneously received. Therefore, the program operation time is reduced.

FIG. 6 is a diagram illustrating an embodiment of the control logic 300 of FIG. 2.

Referring to FIG. 6, there will be described an example of a memory device 1110 including a plurality of TLCs.

During a TLC program operation, LSB data, CSB data and MSB data may be included in logical page data. The control logic 300 may monitor a state of receiving each logical page data. If, as a result of the monitoring, the memory device 1110 completes receiving one of the LSB, CSB and MSB data, the control logic 300 may control the peripheral circuit 200 so that the reception-completed logical page data is preferentially programmed while the memory device 1110 is receiving the other logical page data, reception of which is not completed yet. Detailed description is as follows.

The control logic 300 may include a data-transmission-completion signal output unit 61, an operation control unit 62, a program control unit 63 and a ready/busy signal output unit 64.

The data-transmission-completion signal output unit 51 may monitor a state of receiving the logical page data. For example, the data-transmission-completion signal output unit 61 may monitor states of receiving the LSB data, the CSB data and the MSB data and output an LSB-transmission-completion signal FS_L, a CSB-transmission-completion signal FS_C or an MSB-transmission-completion signal FS_M depending on the reception state of the respective LSB, CSB and MSB data.

In this regard, as well as the page buffer unit 230, the data-transmission-completion signal output unit 61 may also receive from the column decoder 240 the LSB, CSB and MSB data as check data CHK_DATA for monitoring the state of receiving the logical page data. The column decoder 240 may provide the logical page data to the data-transmission-completion signal output unit 61 and the page buffer unit 230 at the same time. The data-transmission-completion signal output unit 61 may output the LSB-transmission-completion signal FS_L, the CSB-transmission-completion signal FS_C or the MSB-transmission-completion signal FS_M according to completion of reception of the respective LSB, CSB and MSB data as the check data CHK_DATA provided from the column decoder 240. If all of the LSB data has been transmitted to the page buffer 230 as well as the data-transmission completion signal output unit 61, the data-transmission-completion signal output unit 61 may output an LSB-transmission-completion signal FS_L according to completion of reception of the LSB data as the check data CHK_DATA. In this way, the data-transmission-completion signal output unit 61 may output the CSB-transmission-completion signal FS_C according to completion of reception of the CSB data as the check data CHK_DATA or output the MSB-transmission-completion signal FS_M according to completion of reception of the MSB data as the check data CHK_DATA.

The operation control unit 62 may output a program operation signal PGM_SIG and a ready signal R_SIG in response to the LSB-transmission-completion signal FS_L, the CSB-transmission-completion signal FS_C or the MSB-transmission-completion signal FS_M. For example, when the LSB-transmission-completion signal FS_L is received, the operation control unit 62 may output the program operation signal PGM_SIG and the read signal R_SIG. The program operation signal PGM_SIG and the read signal R_SIG may be output as a high or low level depending on a coding value set in the memory device 1110. For example, when the LSB-transmission-completion signal FS_L is received, the operation control unit 62 may output the program operation signal PGM_SIG of a high level to perform the LSB program operation. Furthermore, when the LSB-transmission-completion signal FS_L is received, the operation control unit 62 may output the ready signal R_SIG of a high level to receive a command, an address and data for a next operation from the memory controller 1120. If both the CSB and MSBtransmission-completion signals FS_C and FS_M have been received, the operation control unit 62 may convert the ready signal R_SIG into a low level and output it so that a command or data is not received from the memory controller 1120.

The program control unit 63 may output program control signals PGM_CON in response to the program operation signal PGM_SIG. The program control signals PGM_CON may include signals to control the peripheral circuit 200 to perform the program operation.

The ready/busy signal output unit 64 may output a ready/busy signal R/B in response to the ready signal R_SIG. For example, the ready/busy signal R/B may be transmitted to the memory controller 1120 through a ready/busy line coupled between the memory controller 1120 and the memory device 1110. The ready/busy signal output unit 64 may output the ready/busy signal R/B of a high level when the ready signal R_SIG of a high level is received, and output the ready/busy signal R/B of a low level when the ready signal R_SIG of a low level is received. For example, the ready/busy signal output unit 64 may disable the ready/busy signal R/B when the ready signal R_SIG of a high level is received, and enable the ready/busy signal R/B when the ready signal R_SIG of a low level is received. If the ready/busy signal R/B is disabled, the memory device 1110 may receive a command, an address and data. If the ready/bush signal R/B is enabled, the memory device 1110 may not receive a command, an address and data.

The operation of the above-mentioned control logic 300 will be described in detail below.

FIG. 7 is a diagram illustrating an operating method of the control logic 300 of FIG. 2.

Referring to FIG. 7, if all LSB data LSB DATA have been transmitted through input/output lines IO to the memory device 1110 at time point T1, the data-transmission-completion signal output unit 61 included in the control logic 300 may output the LSB-transmission-completion signal FS_L. In this regard, before the program operation starts, all LSB-, CSB- and MSB-transmission-completion signals FS_L, FS_C and FS_M may be initialized to a low level L. Therefore, if all LSB data LSB DATA have been transmitted to the memory device 1110 at time point T1, the data-transmission-completion output unit 61 may transit the LSB-transmission-completion signal FS_L from the low level L to a high level H and output it. If the LSB-transmission-completion signal FS_L becomes a high level H, the program operation signal PGM_SIG may be outputted from the operation control unit 62. If the program operation signal PGM_SIG is outputted, the program control signals PGM_CON are outputted from the program control unit 63, and thus the LSB program operation LSB_PGM may be performed.

While the LSB program operation LSB_PGM is performed, the CSB data CSB_DATA and the MSB data MSB_DATA that are the other logical page data may be successively received to the memory device 1110 through the input/output lines IO. For example, if all CSB data CSB_DATA have been transmitted to the memory device 1110 at time point T2, the data-transmission-completion output unit 61 may transit the CSB-transmission-completion signal FS_C from a low level L to a high level H and output it. Although the CSB-transmission-completion signal FS_C has been transited from the low level L to the high level H, MSB data MSB_DATA must also be received. Therefore, the operation control unit 62 may continuously output the program operation signal PGM_SIG, and the ready signal R_SIG may also be continuously outputted as the high level.

Subsequently, if all MSB data MSB_DATA have been received to the memory device 1110 at time point T3, the data-transmission-completion output unit 61 may transit the MSB-transmission-completion signal FS_M from the low level L to a high level H and output it. If the MSB-transmission-completion signal FS_M is transited from the low level L to the high level H, the operation control unit 62 may continuously output the program operation signal PGM_SIG, and the ready signal R_SIG may be transited from the high level H to the low level L. If the ready signal R_SIG is transited to the low level L, the ready/busy signal output unit 64 may output the ready/busy signal R/B as a low level L.

As described above, if there is logical page data that has been completely received, the memory device 1110 performs a program operation while receiving the other logical page data. This way, the program operation time can be reduced.

The above-mentioned program operation may also be applied to a memory device including a plurality of planes. Detailed description is as follows.

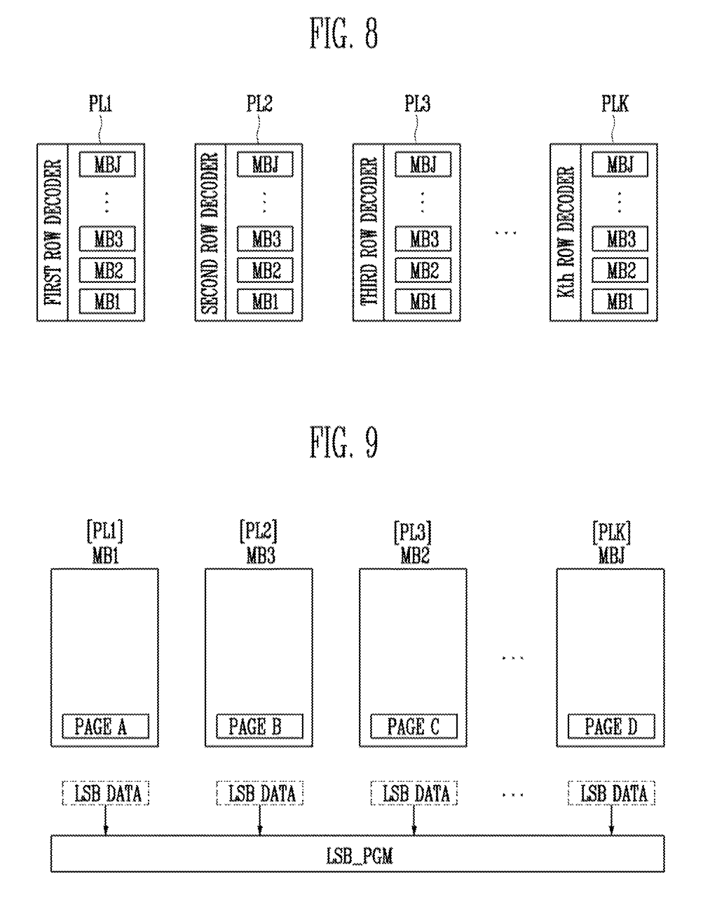

FIG. 8 is a diagram illustrating a memory device including a plurality of planes.

Referring to FIG. 8, the memory device may include first to Kₜₕ planes PL1 to PLK (K is a positive integer). Each of the first to Kₜₕ planes PL1 to PLK may include a plurality of memory blocks MB1 to MBJ (J is a positive integer). Because each of the first to Kₜₕ planes PL1 to PLK includes a plurality of memory blocks MB1 to MBJ, different row decoders may be coupled to the respective planes PL1 to PLK. For example, a first row decoder may be coupled to the first plane PL1, a second row decoder may be coupled to the second plane PL2, and a Kₜₕ decoder may be coupled to the Kₜₕ plane PLK. Among the memory blocks MB1 to MBJ included in each of the first to Kₜₕ planes PL1 to PLK, different memory blocks or different pages may be selected through the first to Kₜₕ row decoders.

A program operation of the memory device including the plurality of planes PL1 to PLK will be described below.

FIG. 9 is a diagram illustrating a program operation, according to a fourth embodiment of the present disclosure.

Referring to FIG. 9, during a program operation, among the memory blocks included in the first to Kₜₕ planes PL1 to PLK, different memory blocks may be selected, and different pages may be selected in each of the selected memory blocks. For example, in the first plane PL1, a first memory block MB1 may be selected and, among pages of the first memory block MB1, a page A may be selected. In the second plane PL2, a third memory block MB3 may be selected, and, among pages of the third memory block MB3, a page B may be selected. In the third plane PL3, a second memory block MB2 may be selected, and, among pages of the second memory block MB2, a page C may be selected. In the Kₜₕ plane PLK, a Jₜₕ memory block MBJ may be selected, and, among pages of the Jₜₕ memory block MBJ, a page D may be selected.

If, among logical page data to be programmed on the page A of the first plane PL1, all LSB data have been inputted to page buffers, and, among logical page data to be programmed on the page B of the second plane PL2, all LSB data have been inputted to page buffers, and, among logical page data to be programmed on the page C of the third plane PL3, all LSB data have been inputted to page buffers, and, among logical page data to be programmed on the page D of the Kₜₕ plane PLK, all LSB data have been inputted to page buffers, LSB program operations LSB_PGM of the respective pages A, B, C and D selected from the first to Kₜₕ planes are performed. While, in the first to Kₜₕ planes, the LSB program operations LSB_PGM of the respective selected pages are performed, CSB data and MSB data are successively inputted to page buffers coupled to the first to Kₜₕ planes PL1 to PLK.

As described above, in the case where a plurality of planes are included in the memory device, if all identical logical page data have been received regardless of memory blocks or page addresses, program operations of the respective pages may be performed for the type of logical page data for which reception has been completed. While the program operations are performed, the other type of logical page data are received to the memory device. As such, since the program operation and some of the data receiving operation are performed at the same time, the program operation time can be reduced.

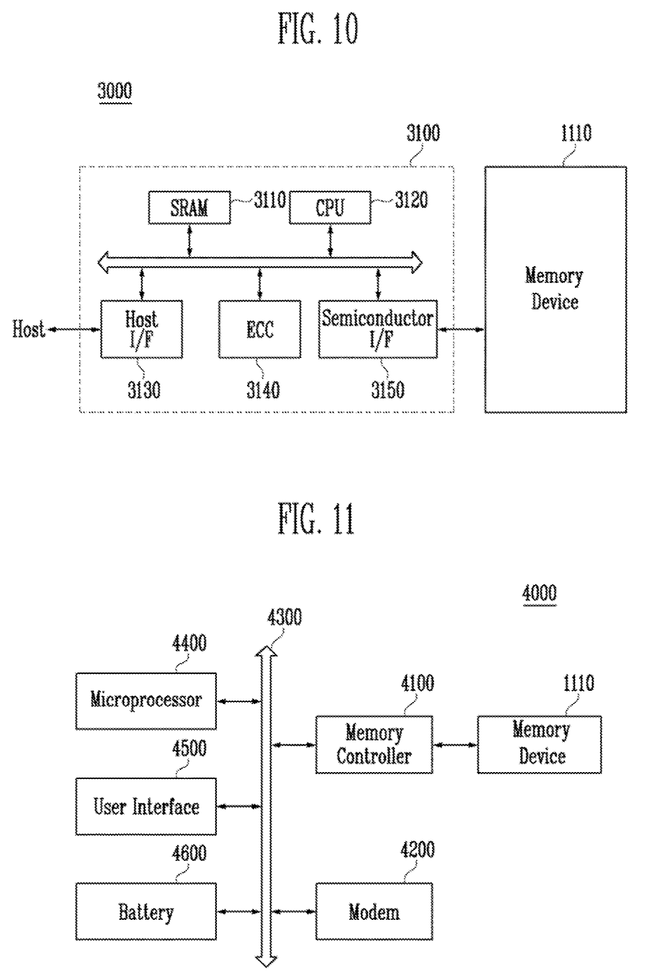

FIG. 10 is a diagram illustrating a memory system, according to another embodiment of the present disclosure. A memory device 1110 may have the substantially same configuration as that of FIG. 2; therefore, detailed description of the memory device 1110 will be omitted.

Referring to FIG. 10, the memory system 300 may include a control unit 3100 and a memory device 1110. The control unit 3100 may be configured to control the memory device 1110. An SRAM 3110 may be used as a working memory of a CPU 3120. A host interface (3130; Host I/F) includes a data exchange protocol of a host connected to the memory system 3000. An error correction circuit (ECC) 3140 provided in the control unit 3100 may detect and correct an error included in data read from the memory device 1110. A semiconductor interface (3150; Semiconductor I/F) may be configured to interface with the memory device 1110. The CPU 3120 may perform control operations for data exchange of the controller 3100. Although not illustrated in FIG. 10, the memory system 3000 may further include a ROM (not shown) for storing code data to interface with the host. An internal bus may be employed for providing a communication link between the various components of the controller 3100.

The memory system 3000 according to the present embodiment may be applied to a device, such as a computer, a ultra mobile PC (MPC, workstation, net-book, a personal digital assistant (PDA), a portable computer, a web tablet, a wireless phone, a mobile phone, a smart phone, a digital camera, a digital audio recorder, a digital audio player, a digital picture recorder, a digital picture player, a digital video recorder, a digital video player, a device capable of transmitting/receiving information in an wireless environment one of various devices for forming a home network, or the like.

FIG. 11 is a diagram illustrating a memory system according to another embodiment of the present disclosure. In this embodiment, a memory device 1110 may have substantially the same configuration as that of FIG. 2; therefore, detailed description of the memory device 1110 will be omitted.

Referring to FIG. 11, a computing system 4000 may include a memory device 1110, a memory controller 4100, a modem 4200, a microprocessor 4400 and a user interface 4500 which are electrically coupled to a bus 4300. If the computing system 4000 according to the present embodiment is a mobile device, an addition& battery 4600 may be provided to supply an operating voltage of the computing system 4000. Although not shown in the drawing, the computing system 4000 according to the present embodiment may further include an application chip set, a camera image processor (CIS), a mobile DRAM, or the like.

The memory controller 4100 and the memory device 1110 may form a solid state drive/disk (SSD).

The system according to the present embodiment may be mounted using packages of various forms. For example, the system may be mounted using packages such as Package on Package (PoP), Ball grid arrays (BGAs), Chip scale packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Thin Quad Flatpack (TQFP), Small Outline (SOIC), Shrink Small Outline Package (SSOP), Thin Small Outline (TSOP), System In Package (SIP), Multi Chip Package (MCP), Wafer-level Fabricated Package (WFP), Wafer-Level Processed Stack Package (WSP), or the like.

The present invention improves the reliability of a program operation of a memory device and the retention characteristic of the memory device.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A memory device comprising:
a memory cell array including a plurality of pages;
a peripheral circuit suitable for successively receiving a plurality of logical page data, and performing a program operation with the received logical page data to a selected page; and
a control logic suitable for controlling the peripheral circuit to perform, in parallel, the program operation to the selected page with reception-completed logical page data among the plurality of logical page data while receiving other logical page data.

2. The memory device according to claim 1,
wherein the control logic further monitors a state of receiving the respective logical page data, and
wherein the control logic controls the peripheral circuit to perform the program operation to the selected page with the reception-completed logical page data according to a result of the monitoring.

3. The memory=device according to claim 1, wherein the control logic comprises:
a data-transmission-completion signal output unit suitable for monitoring a state of receiving the respective logical page data and outputting one of transmission-completion signals respectively corresponding to the plurality of logical page data depending on a result of the monitoring;
an operation control unit suitable for outputting a program operation signal and a ready signal in response to the outputted one of the transmission-completion signals;
a program control unit suitable for outputting program control signals for controlling the peripheral circuit to perform the program operation to the selected page with the reception-completed logical page data in response to the program operation signal; and
a ready/bush signal output unit suitable for outputting a ready/busy signal to a memory controller in response to the ready signal.

4. The memory device according to claim 3, wherein, when reception of one of the plurality of logical page data is determined to be completed according to the result of the monitoring, the data transmission-completion signal output unit outputs one of the transmission-completion signals corresponding to the reception-completed logical page.

5. The memory device according to claim 3, wherein the operation control unit keeps outputting the program operation signal in response to a firstly provided one of the transmission-completion signals.

6. The memory device according to claim 3, wherein the operation control unit outputs the ready signal until all of the transmission-completion signals are provided.

7. The memory device according to claim 1, wherein the peripheral circuit includes page buffers suitable for receiving the logical page data.

8. The memory device according to claim 7, wherein the control logic further monitors a state of receiving the respective logical page data using the logical page data provided to the page buffers.

9. The memory device according to claim 1,
wherein the memory cell array comprises a plurality of planes each of which includes a plurality of memory blocks,
wherein each of the memory blocks includes a plurality of pages.

10. The memory device according to claim 9,
wherein the control logic further monitors a state of receiving the logical page data to be programmed on selected ones of the planes, and
wherein the control logic controls the peripheral circuit to perform the program operation to the selected pages of the selected planes with the reception-completed logical page data according to a result of the monitoring.

11. An operating method of a memory device comprising:
receiving first to Nₜₕ logical page data;
performing a program operation to a selected page with reception-completed one among the first to Nₜₕ logical page data; and
receiving the other logical page data during the performing of the program operation with the reception-completed logical page data.

12. The operating method according to claim 11, further comprising performing the program operation to the selected page with the other logical page data after the performing of the program operation with the reception-completed logical page data and the receiving of the other logical page data.

13. An operating method of a memory device comprising:
receiving least significant bit (LSB) data, central significant bit (CSB) data and most significant bit (MSB) data;
performing a program operation to selected page with the LSB data, which is reception-completed;
receiving the CSB data and the MSB data during the performing of the program operation with the reception-completed LSB data; and
performing the program operation to the selected page with the CSB and MSB data after the performing of the program operation with the reception-completed LSB data and the receiving of the CSB and MSB data.

14. The operating method according to claim 13, wherein the performing of the program operation with the reception-completed LSB data comprises:
outputting an LSB-transmission-completion signal upon completion of receiving the LSB data;
outputting a program operation signal in response to the LSB-transmission-complete signal; and
outputting program control signals for performing the program operation to the selected page in response to the program operation signal.

15. Tie operating method according to claim 14, further comprising outputting a ready/busy signal when the program operation signal is outputted.

16. The operating method according to claim 15, wherein the ready/busy signal is output until completion of the receiving of all of the LSB data, the CSB data and the MSB data.

17. The operating method according to claim 13, wherein all of the CSB data and the MSB data are received before the program operation with the LSB data is completed.
